(19) United States
(12) Patent Application Publication
(10) Pub. No.: US 2014/0365963 A1
(43) Pub. Date: Dec. 11, 2014

(54) APPLICATION BAR FLYOUTS

(71) Applicant: Microsoft Corporation, Redmond, WA (US)

(72) Inventors: Christopher Garty, Fargo, ND (US); Kevin Honeyman, Fargo, ND (US); Michael M. Santos, Seattle, WA (US); Brian Glaeske, Fargo, ND (US); Todd Lefor, Fargo, ND (US)

(21) Appl. No.: 13/913,039

(22) Filed: Jun. 7, 2013

(51) Int. Cl. G06F 3/0482; G06F 3/0484

(52) U.S. Cl. CPC G06F 3/0482; G06F 3/04847
USPC 715/810

(57) ABSTRACT

An application bar is displayed along with a form. The application bar includes a set of controls for performing actions. At least one of the controls has an associated flyout menu. When the user actuates the control, the flyout menu displays groups of flyout controls, without obscuring the display of the controls on the application bar.

### BACKGROUND

Computer systems are currently in wide use. Many different kinds of computer systems are configured to offer the user multiple contextual options.

For instance, a computer system can display a context-sensitive menu for user interaction. The menu items can be changed based upon the context of the application (or computer system) at the time the display is generated. The user can choose from among the multiple different options by actuating different items on the menu.

Many computer systems are quite large. For example, many different types of business systems (or business applications) can contain a great deal of information as well as many different user interface displays that are offered to a user during operation. Such systems can include, for example, customer relations management (CRM) systems, enterprise resource planning (ERP) systems, line-of-business (LOB) systems, etc. These types of systems often include thousands of different forms, and provide many thousands of controls on the forms. Thus, it can be difficult to present this type of information (and the multiple different contextual options) to a user, for user interaction, in a way that is relatively straight forward and intuitive.

The discussion above is merely provided for general background information and is not intended to be used as an aid in determining the scope of the claimed subject matter.

### SUMMARY

An application bar is displayed along with a form. The application bar includes a set of controls for performing actions. At least one of the controls has an associated flyout menu. When the user actuates the control, the flyout menu displays groups of flyout controls, without obscuring the display of the controls on the application bar.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system.

FIG. 2 is a flow diagram illustrating one embodiment of the overall operation of the business system shown in FIG. 1 in generating flyout displays.

FIGS. 2A-2G are illustrative user interface displays.

FIG. 3 is a block diagram of the business system shown in FIG. 1 in various architectures.

FIGS. 4-9 show various embodiments of mobile devices.

FIG. 10 is a block diagram of one illustrative computing environment.

### DETAILED DESCRIPTION

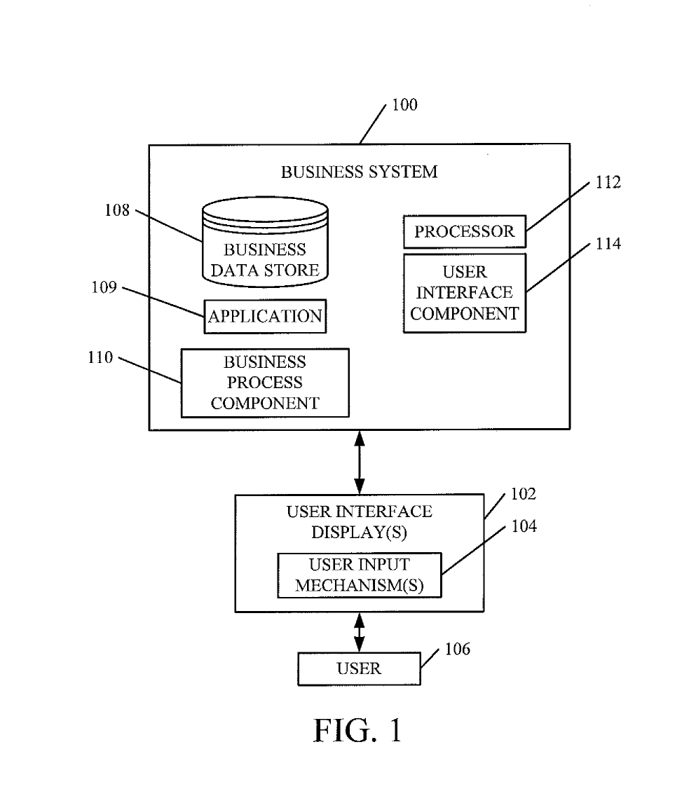

FIG. 1 is a block diagram of one embodiment of business system 100. It will be appreciated that the flyout displays described herein can be used in substantially any application or system which offers the user multiple contextual options. However, the present discussion will proceed with respect to the application (or system) being a business system (such as an ERP system, a CRM system, an LOB system, etc.).

Business system 100 generates user interface displays 102 with user input mechanisms 104 for interaction by user 106. User 106 illustratively interacts with the user input mechanisms 104 in order to control and manipulate business system 100.

Business system 100 illustratively includes business data store 108, application 109, business process component 110, processor 112 and user interface component 114. Of course, it can include other items as well.

Business data store 108 illustratively includes entities or other types of business records. It can also include various workflows. The business records stored in business data store 108 can illustratively include entities which describe various aspects of the business. For instance, the entities can include opportunity entities that describe various business opportunities. They can include vendor entities that describe vendors, inventory entities that describe inventory, product entities that describe products, customer entities that describe customers, etc. Each of these entities can include a wide variety of different types of data or information related to the particular thing that it describes.

Application 109 can be used to implement various business processes or tasks and activities that are performed in order to run a business. Application 109 can illustratively operate on the data in business data store 108, in response to various user inputs, or automatically.

Business process component 110 illustratively executes workflows on entities or other business records, based on user inputs as well. Both application 109 and business process component 110 (or other items in business system 100) can illustratively use user interface component 114 to generate user interface displays 102.

Processor 112 is illustratively a computer processor with associated memory and timing circuitry (not separately shown). It is illustratively a functional part of business system 100 and is activated by, and facilitates the functionality of, other components or items in business system 100.

Data store 108 is shown as a single data store, and it is local to system 100. It should be noted, however, that it can be comprised of multiple different data stores as well. Also, one or more data stores can be remote from system 100 or local to system 100, or some can be local while others are remote.

User input mechanisms 104 can take a wide variety of different forms. For instance, they can be text boxes, active tiles, check boxes, icons, links, dropdown menus, buttons, or other input mechanisms. In addition, they can be actuated by user 106 in a variety of different ways. For instance, they can be actuated using a point and click device (such as a mouse or track ball), using a soft or hard keyboard, a thumbpad, a keypad, various buttons, a joystick, etc. In addition, where the device on which user interface displays 102 are displayed has a touch sensitive screen, they can be actuated using touch gestures (such as with a user's finger, a stylus, etc.). Further, where the device or system includes speech recognition components, user input mechanisms 104 can be actuated using voice commands.

It will also be noted that multiple blocks are shown in FIG. 1, each corresponding to a portion of a given component or functionality performed in system 100. The functionality can be divided into additional blocks or consolidated into fewer blocks. All of these arrangements are contemplated herein.

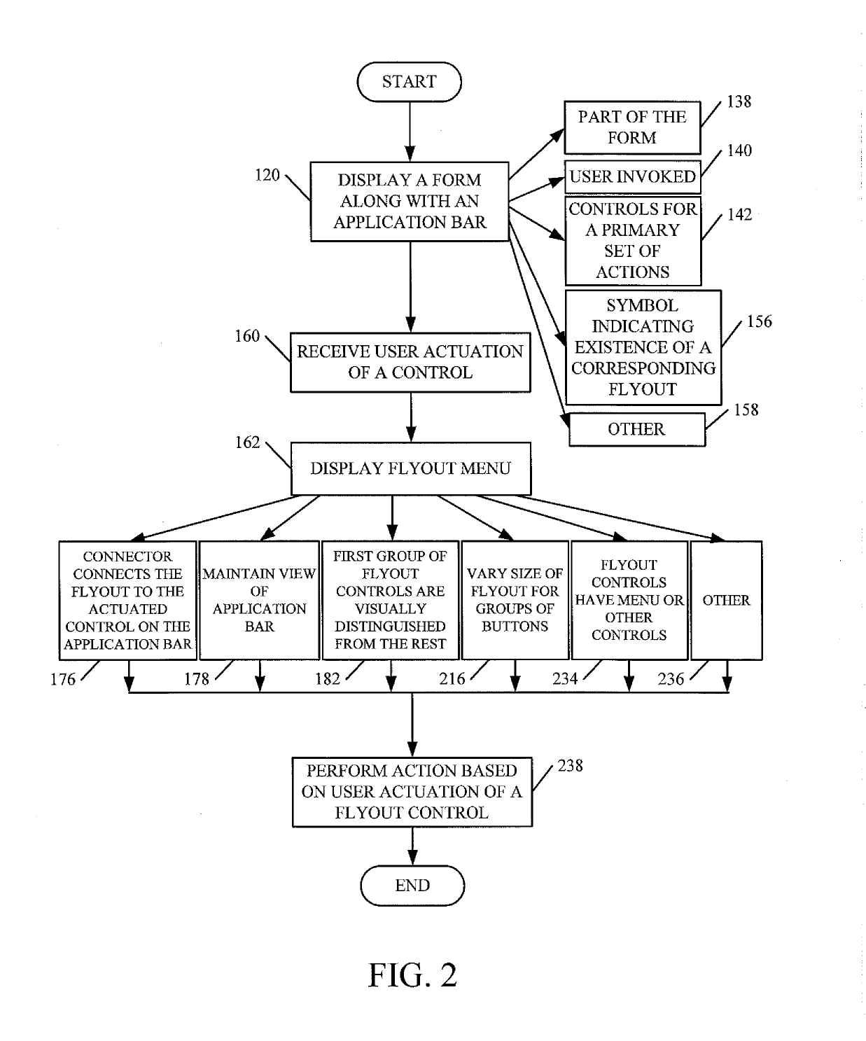

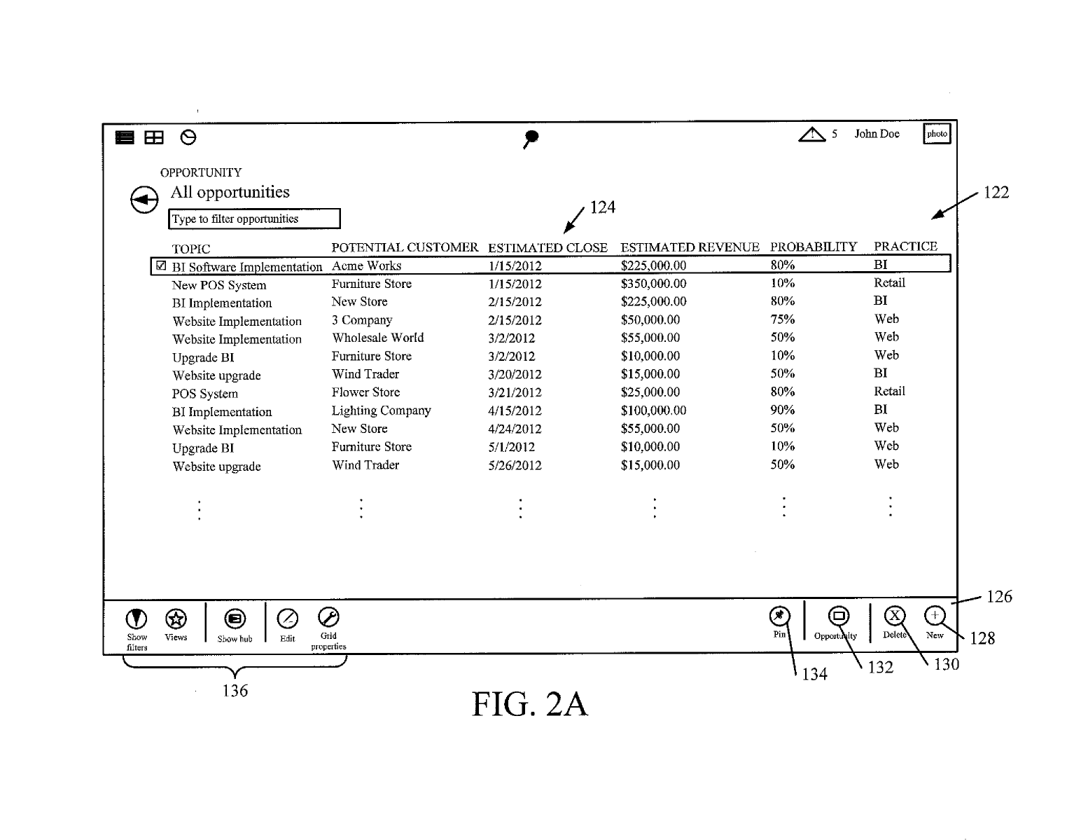

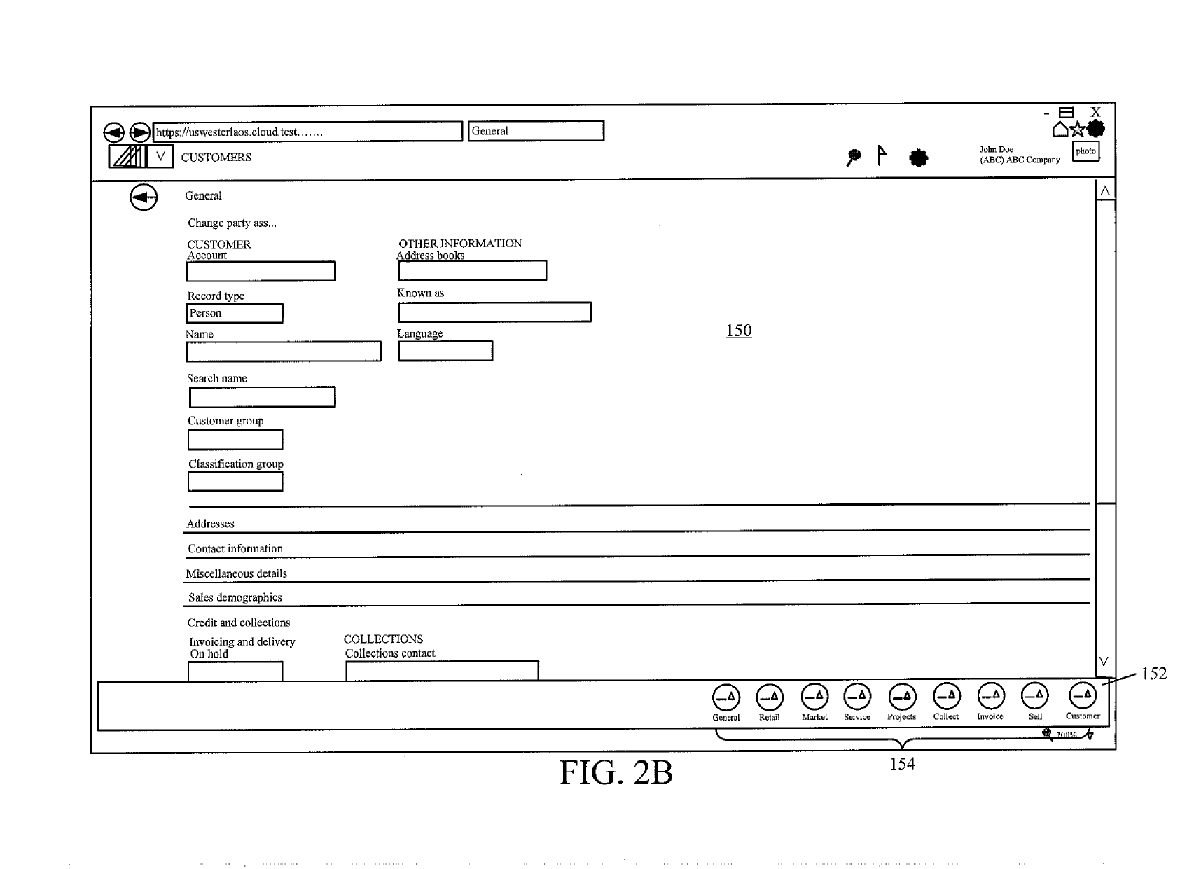

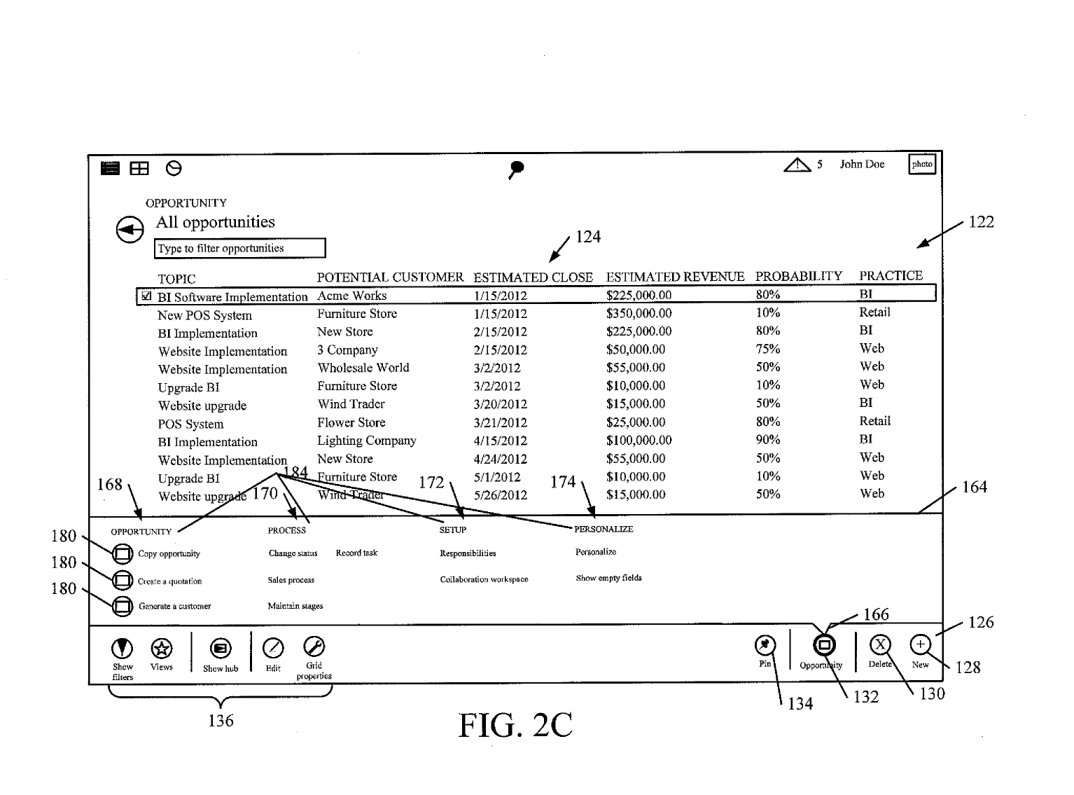

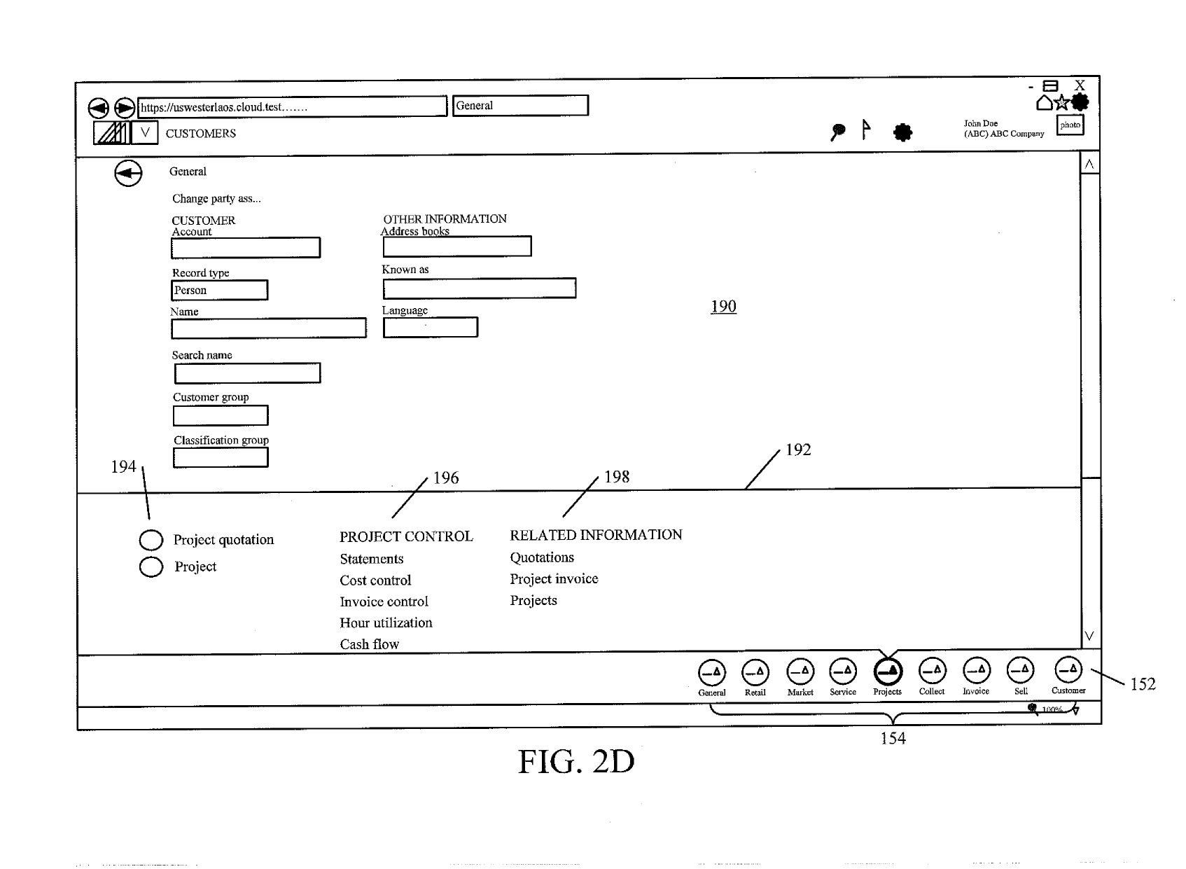

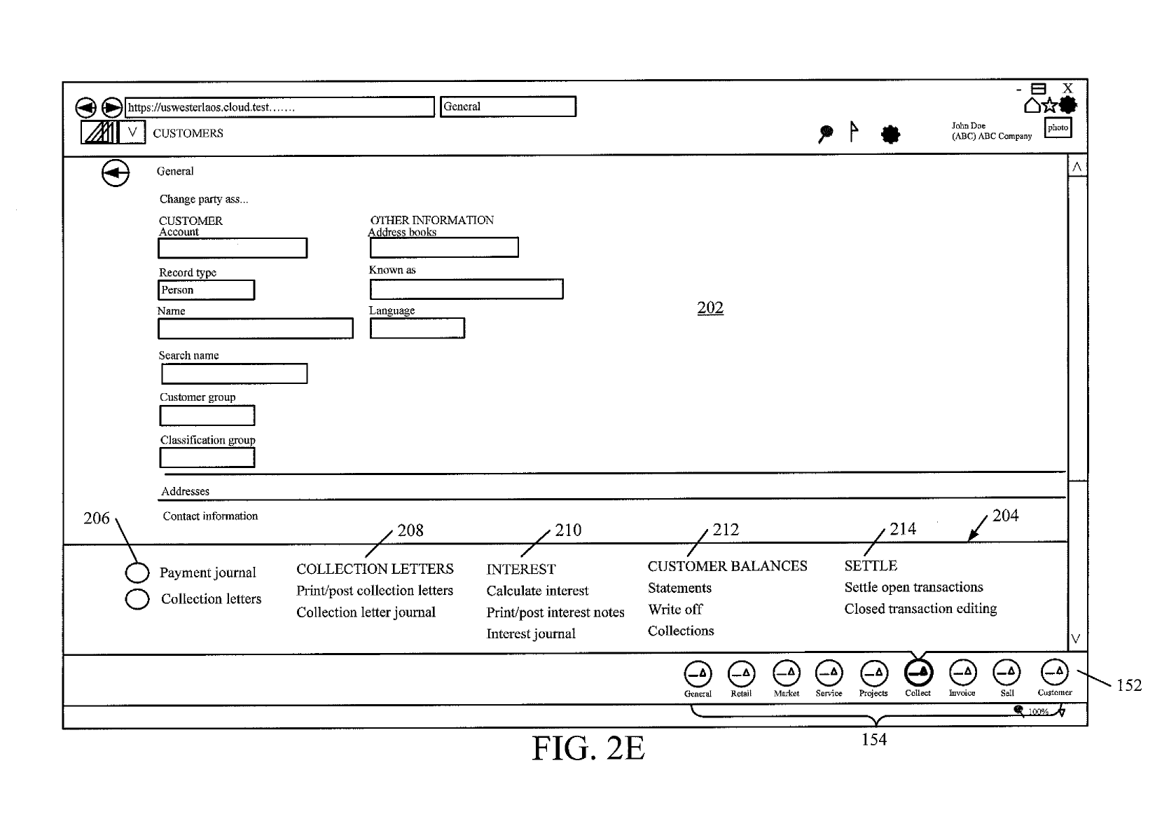

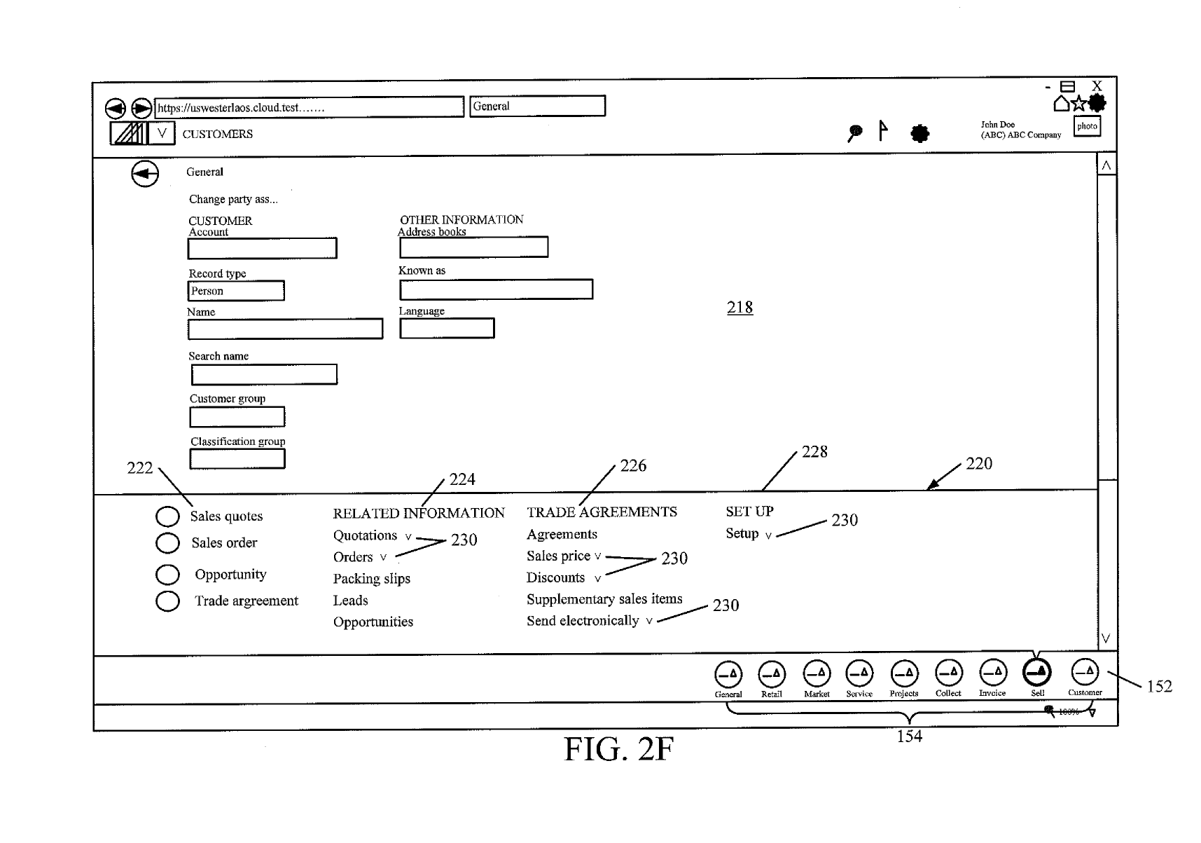

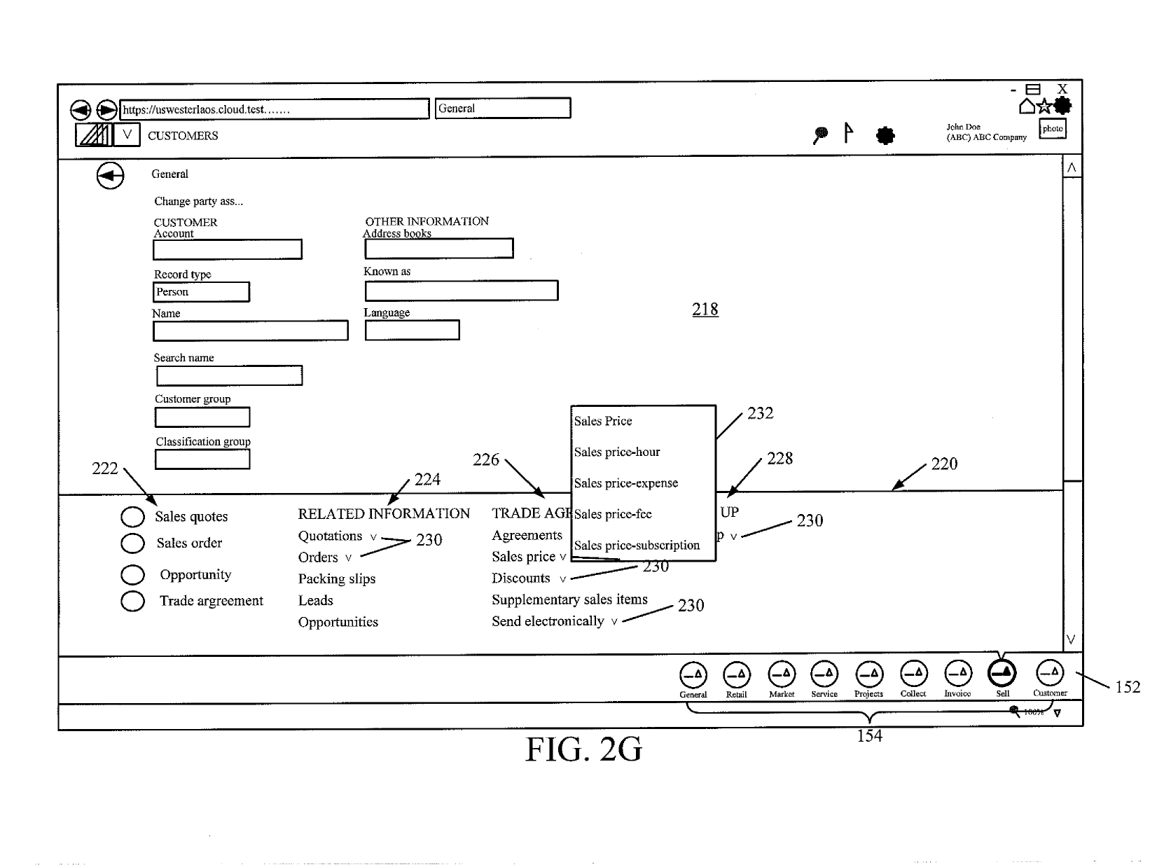

FIG. 2 is a flow diagram illustrating the operation of business system 100 in presenting user 106 with multiple contextual options within the operation of business system 100. FIGS. 2A-2G are illustrative user interface displays that illustrate the operation as well. FIGS. 2-2G will now be described in conjunction with one another.

Application 109 or business process component 110 (or another item in business system 100) first uses user interface component 114 to display a form from the business system 100, along with an application bar. This is indicated by block 120 in FIG. 2. FIG. 2A shows a user interface display 122 that indicates this. User interface display 122 is illustratively a user interface display that shows a list 124 of opportunity entities in business data store 108. User 106 has illustratively requested system 100 to display this form.

It can be seen that the form displayed as user interface display 122 also includes an application bar 126. The application bar 126 includes a plurality of control user input mechanisms (or controls) that correspond to actions that can be taken when a control is actuated by the user. The controls include, for instance, new control 128 that allows the user to create a new record, delete control 130 that allows the user to delete a record, opportunity control 132 that allows the user to take various actions with respect to a selected opportunity entity or other opportunity entities, a pin control 134 that allows the user to select information to be added to various displays, and a plurality of additional controls 136 that allow the user to perform other actions as well. It should be noted that application bar 126 can include any of a wide variety of different types of controls. The controls 128-136 are shown for the sake of example only.

Referring again to the flow diagram of FIG. 2, application bar 126 can be part of the form on which it is displayed. This is indicated by block 138 in FIG. 2. Therefore, each time the form is displayed, the application bar is also displayed. Alternatively, it can be invoked by the user, as indicated by block 140. For instance, it may be that the form is simply displayed without application bar 126 being displayed. Then, when the user performs a suitable user input (such as a swipe gesture or a point and click input, etc.) the user invokes the display of application bar 126. User interface component 114 then displays application bar 126 over the form. In any case, application bar 126 includes the set of controls (such as controls 128-136) for performing a primary set of actions. This is indicated by block 142 in FIG. 2.

In the embodiment shown in FIG. 2A, the application bar displays the controls 128-136 with symbols disposed thereon. It should be noted, however, that this can vary. For instance, FIG. 2B shows a user interface display 150 with another application bar 152. Application bar 152 includes a set of controls 154. Each control 154 is shown with a default symbol on it. The default symbol gives a visual indication that, if the user actuates that control, a flyout menu will be displayed. Displaying the application bar with a symbol indicating the existence of a corresponding flyout menu is indicated by block 156 in FIG. 2. Of course, displaying the application bar can include displaying other information 158 as well.

Once the application bar 126 (or 152) is displayed, user 106 actuates one of the controls on the application bar in order to be provided with a more detailed set of contextual options. Receiving user actuation of a control on the application bar is indicated by block 160 in FIG. 2.

In response to receiving user actuation of one of the controls on application bar 126, user interface component 114 displays a flyout menu corresponding to the actuated control. This is indicated by block 162. FIG. 2C shows one embodiment of the user interface display 122 (shown in FIG. 2A) with flyout menu 164. It can be seen that flyout menu 164 has a connector portion 166 that visually connects it to the control on application bar 126 that was actuated to generate flyout menu 164. By way of example, FIG. 2C shows that the user has actuated the control 132 on application bar 126 in order to generate flyout menu 164. This can be seen because the visual connector 166 visually connects flyout menu 164 with control 132. Displaying a connector that connects flyout menu 164 with the actuated control 132 is indicated by block 176 in FIG. 2.

A number of different things can be noted from the display shown in FIG. 2C. It can be seen that flyout menu 164 includes a plurality of different groups 168, 170, 172 and 174 of additional user input mechanisms (or controls or buttons) that can be actuated by the user. All of these controls are options that the user can exercise in the context of the underlying form shown on user interface display 122, and in the context of actuation of control 132 on application bar 126. Because flyout menu 164 does not obscure the controls on application bar 126, the display is highly intuitive. That is, the user can easily maintain the context within which the options in flyout menu 164 are presented. The user can still see a large portion of the underlying form in user interface display 122, the user can see all of the controls on application bar 126, and the user can quickly identify which control he or she actuated in order to produce the display of flyout menu 164. Maintaining the display of application bar 126, even while flyout menu 164 is displayed, is indicated by block 178 in FIG. 2.

Further, flyout menu 164 displays a first group 168 that is visually distinguished from the remaining groups 170-174. In the embodiment shown in FIG. 2C, each button or menu option in group 168 has an associated visual element 180 which the remaining options in groups 170-174 do not have. In one embodiment, this difference in visual appearance of the controls or menu items in group 178 indicates that they are more important than (such as more frequently used, more relevant, or otherwise distinguishable from) the remaining options. Displaying the first group of flyout controls with a visually distinguished appearance is indicated by block 182 in the flow diagram of FIG. 2.

Also, it can be seen that each group 168-174 has a title or header 184. The titles or headers illustratively provide an indication as to the general subject matter of each of the options or menu items offered in that group.

It should also be noted that, in one embodiment, user interface component 114 varies the size of the flyout menu, based upon the number of options in each of the groups, to accommodate the display of all desired options in each group. FIG. 2D shows one embodiment of a user interface display 190 that illustrates this. User interface display 190 is similar to user interface display 150 shown in FIG. 2B, and similar items are similarly numbered. It can be seen that the projects control 154 on application bar 152 has been actuated by the user in order to generate the display of flyout menu 192. Flyout menu 192 includes action buttons 194 which can be actuated by the user to perform actions. It also includes groups 196 and 198 of menu items that can be actuated by the user. It can be seen that group 196 has at least five menu items. Thus, the display of the menu items in group 196 is relatively tall, in the vertical direction of user interface display 190. It can thus be seen that the vertical height of flyout menu 192 has been adjusted (increased over the height of flyout menu 164 in FIG. 2C, for example) in order to accommodate the increased vertical dimension of group 196.

FIG. 2E shows a user interface display 202, which is similar to user interface display 190 shown in FIG. 2D, except that the “collect” control 154 from application bar 152 has been actuated to produce the display of flyout menu 204. It can be seen that flyout menu 204 not only includes action buttons 206, but it also includes groups 208, 210, 212 and 214. Thus, while there are more groups, none of the groups has as many menu items as group 196 shown in FIG. 2D. Therefore, the vertical height of flyout menu 204 is reduced over that of flyout menu 192 shown in FIG. 2D. Varying the size of the flyout menu to accommodate the groups of buttons is indicated by block 216 in FIG. 2.

FIG. 2F shows another embodiment of a user interface display 218. User interface display 218 is similar to user interface display 202 shown in FIG. 2E, and similar items are similarly numbered. However, FIG. 2F shows that the cell control 154 in application bar 152 has been actuated by the user in order to produce the display of flyout menu 220. Flyout menu 220 includes a plurality of action buttons 222 and a plurality of groups 224, 226 and 228, each of which provide one or more menu items that give contextual options for the user.

It can be seen that a plurality of the menu items (particularly menu items in groups 224-228) have a visual indicator 230. Visual indicator 230 shows that each of the flyout menu items that are displayed adjacent to an indicator 230 have a menu associated with them. Therefore, this illustrates that any given flyout menu (such as flyout menu 220) can present contextual menu options to the user which, themselves, produce additional displays while maintaining the context of the choices made by the user to that point. FIG. 2G illustrates this in more detail.

FIG. 2G is similar to FIG. 2F, and similar items are similarly numbered. However, it can be seen in FIG. 2G that the user has actuated the “sales price” menu option in group 226 on flyout menu 220. Because the sale price option in group 226 has an associated visual indicator 230, it generates a popup menu 232. It can be seen from FIG. 2G that popup menu 232 does not obscure the controls on application bar 152, nor does it obscure the “sale price” menu option that was actuated by the user. Thus, even with menu 232 displayed, the user can still see the underlying form for which user interface display 218 was generated. The user can still see all of the controls on application bar 152, and the user can see a majority of the controls on flyout menu 220, along with the “sales price” menu item in group 226, that the user actuated to produce the display of menu 232. Displaying the flyout controls with menu or other controls on them is indicated by block 234 in FIG. 2.

It can be seen from the above examples that the flyout menu can be displayed and visually connected to an actuated control on the application bar. The size can vary, based upon the menu items presented in the flyout menu, and it is displayed without obscuring the application bar. Various groups in the flyout menu can be visually distinguished from the other groups to indicate their importance, frequency of use, etc. The flyout menu can also include menu items which, themselves, have associated controls. Of course, the flyout menu can be displayed with other information as well, and this is indicated by block 236 in FIG. 2.

Once the user has actuated any given menu item on any given flyout menu, processor 112 (shown in FIG. 1) illustratively takes action based on that user input (as directed by application 109 or business process component 110 or any other component or item in business system 100). This is indicated by block 238 in FIG. 2.

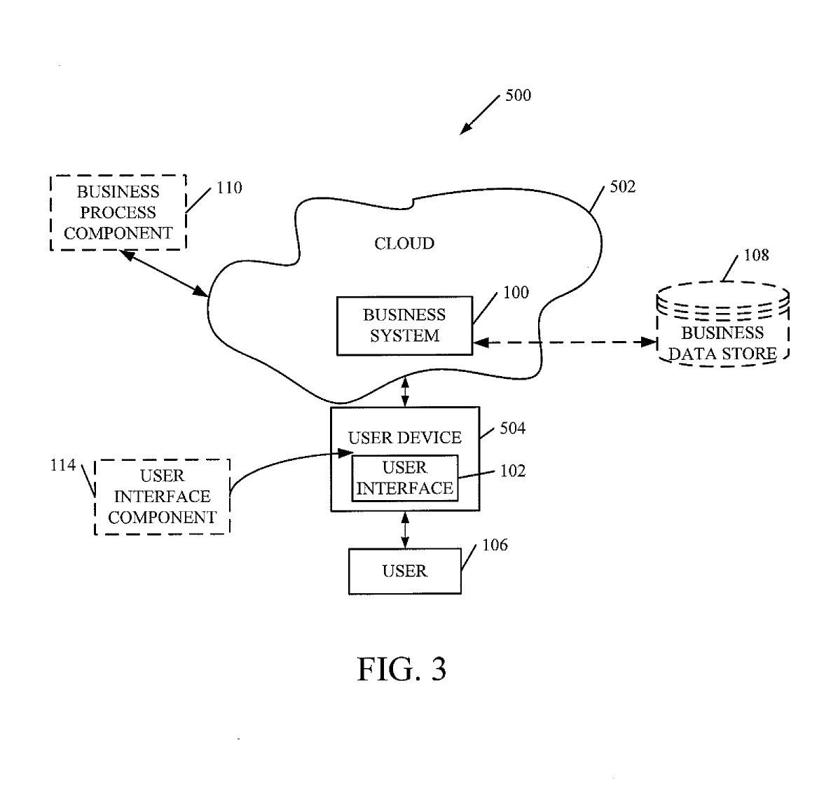

FIG. 3 is a block diagram of system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 3, some items are similar to those shown in FIG. 1 and they are similarly numbered. FIG. 3 specifically shows that system 100 is located in cloud 502 (which can be public, private, or a combination where portions are public while others are private). Therefore, user 106 uses a user device 504 to access system 100 through cloud 502.

FIG. 3 also depicts another embodiment of a cloud architecture. FIG. 3 shows that it is also contemplated that some elements of system 100 are disposed in cloud 502 while others are not. By way of example, data store 108 can be disposed outside of cloud 502, and accessed through cloud 502. In another embodiment, business process component 110 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

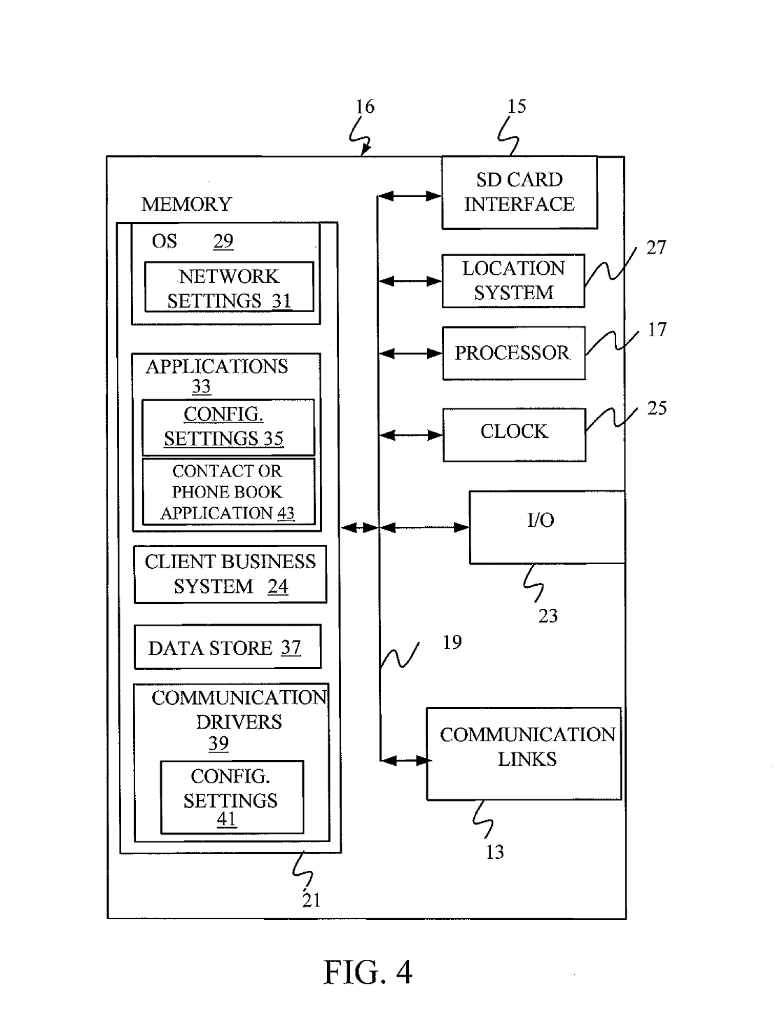

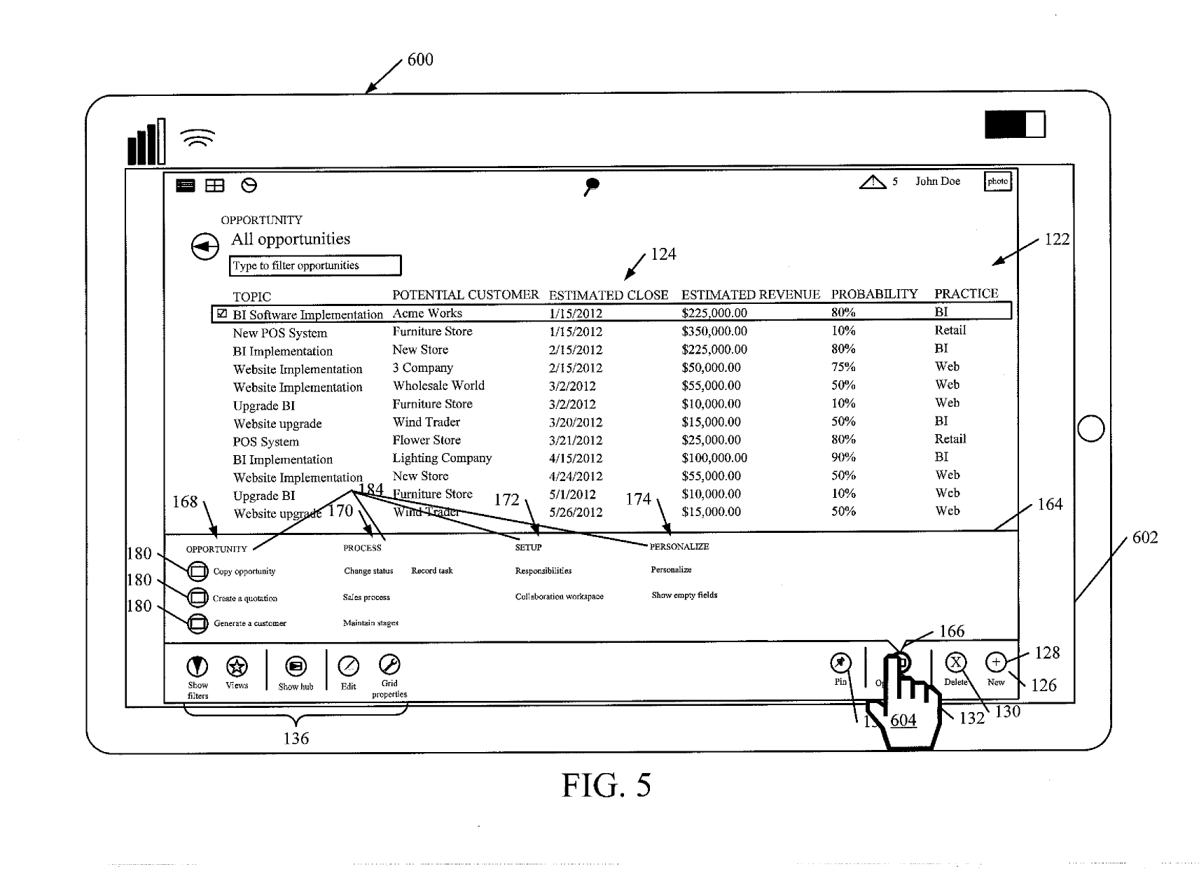

FIG. 4 is a simplified block diagram of one illustrative embodiment of a handheld or mobile computing device that can be used as a user's or client's hand held device 16, in which the present system (or parts of it) can be deployed. FIGS. 5-9 are examples of handheld or mobile devices.

FIG. 4 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 112 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client business system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 5 shows one embodiment in which device 16 is a tablet computer 600. In FIG. 5, computer 600 is shown with user interface display 122 (From FIG. 2A) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

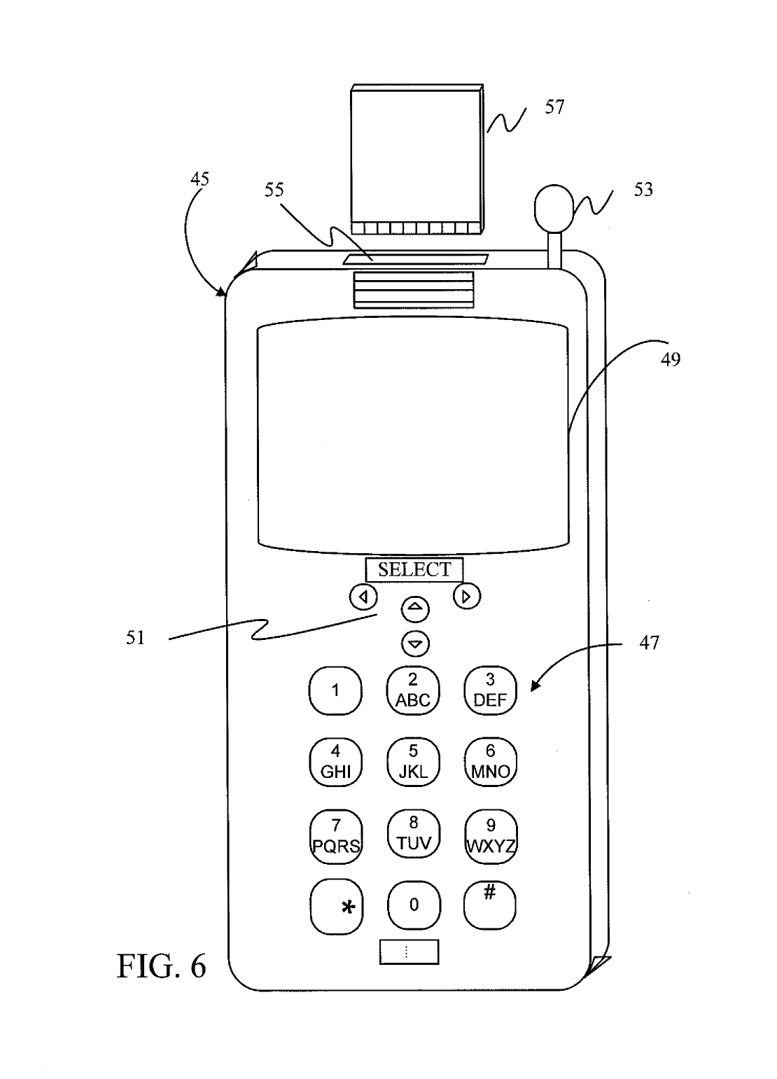

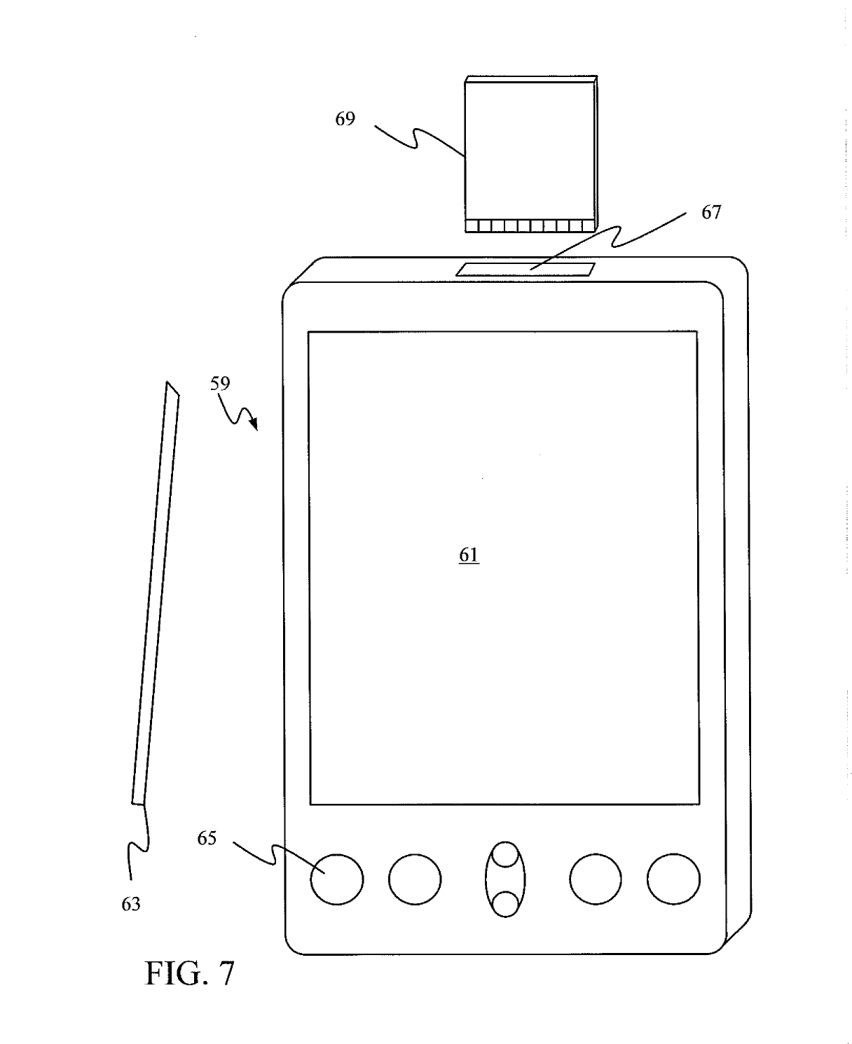

FIGS. 6 and 7 provide additional examples of devices 16 that can be used, although others can be used as well. In FIG. 6, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 7 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

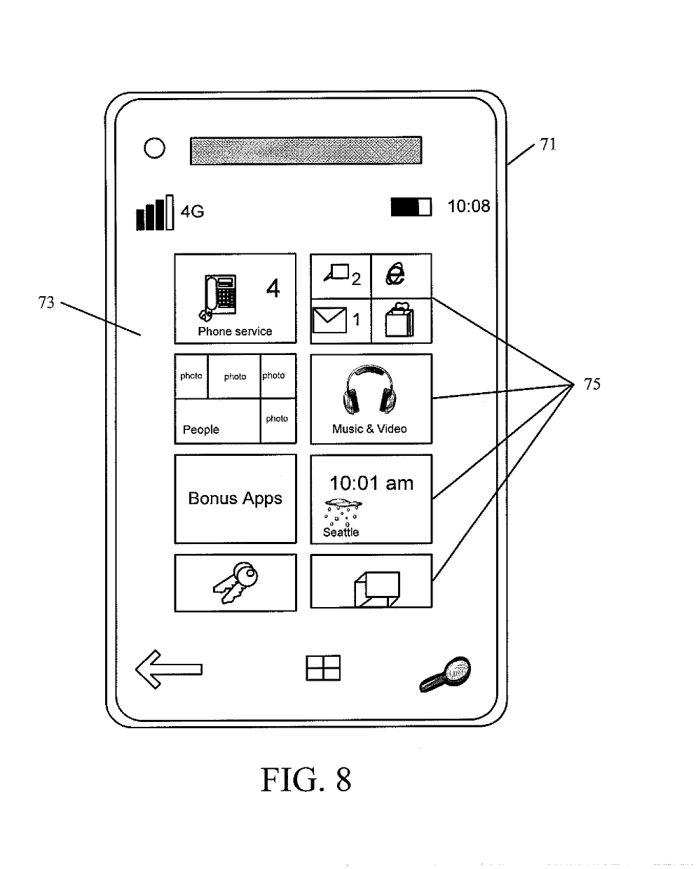

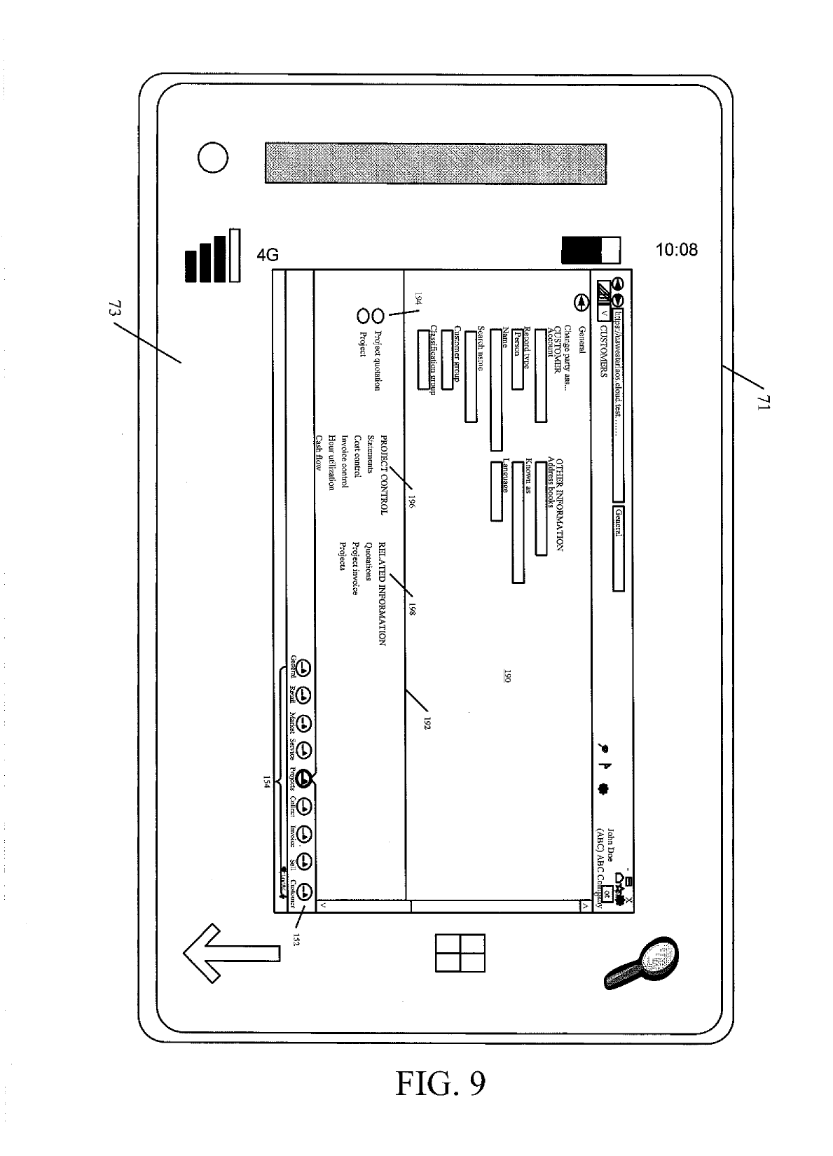

FIG. 8 is similar to FIG. 6 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 9 shows phone 71 with display 190 (from FIG. 2D) displayed on it.

Note that other forms of the devices 16 are possible.

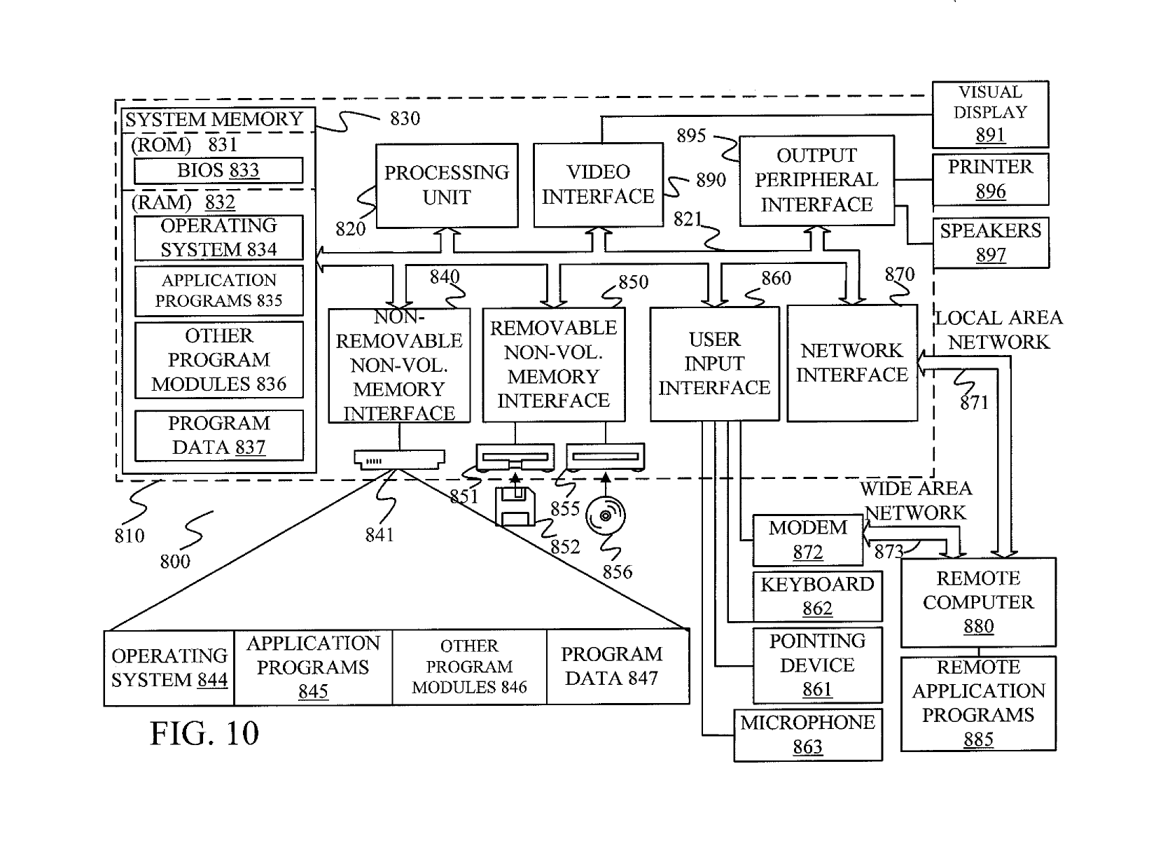

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 112), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of controlling a computer system, comprising:
displaying a user interface display from the computer system;
displaying, along with the user interface display, an application bar having a first set of control user input mechanisms;
receiving user actuation of a given control user input mechanism, of the first set of control user input mechanisms, on the application bar; and
in response to receiving user actuation of the given control user input mechanism, displaying a menu, corresponding to the given control user input mechanism, with a second set of control user input mechanisms, the menu being visually connected to the given control user input mechanism and being displayed so the first set of control user input mechanisms on the application bar remain visually un-obscured by the menu.

2. The computer-implemented method of claim 1 wherein displaying a user interface display from the computer system comprises:
displaying a form from a business system that comprises the computer system.

3. The computer-implemented method of claim 2 wherein displaying an application bar comprises:
automatically displaying the application bar along with the form.

4. The computer-implemented method of claim 2 wherein displaying an application bar comprises:
receiving a user invocation input on the displayed form; and
in response to receiving the user invocation input, displaying the application bar, along with the form.

5. The computer-implemented method of claim 1 wherein displaying the menu with the second set of control user input mechanisms, comprises:
displaying the second set of control user input mechanisms grouped into a plurality of groups on the menu, each group having a corresponding title identifying a subject matter of the corresponding group.

6. The computer-implemented method of claim 5 wherein a first group, of the plurality of groups, is displayed in a form that visually distinguishes it from a remainder of the plurality of groups.

7. The computer-implemented method of claim 6 wherein the first group has a most important group of control user input mechanisms from the second set of control user input mechanisms displayed on the menu.

8. The computer-implemented method of claim 5 wherein displaying the menu comprises:
varying a size of the menu based on a number of the second set of control user input mechanisms in a largest group of the plurality of groups.

9. The computer-implemented method of claim 1 wherein displaying the application bar comprises:
displaying the first set of control user input mechanisms having associated symbols, each symbol being indicative of whether an associated one of the first set of control user input mechanisms has a corresponding menu.

10. The computer-implemented method of claim 2 wherein displaying the menu comprises:
displaying a visual menu indicator associated with each of the second set of control user input mechanisms that, itself, has an additional menu corresponding to it, wherein actuation one of the second set of control user input mechanisms having an associated visual menu indicator causes display of a corresponding additional menu, along with the form, the application bar, and the menu.

11. A computer system, comprising:
an application component;
a user interface component that generates user interface displays for the application, the user interface component displaying, along with a given user interface display, an application bar having first and second control user input mechanisms and, in response to receiving user actuation of the first control user input mechanism, displaying a menu, corresponding to the first control user input mechanism, with a group of additional control user input mechanisms, the menu being displayed so the first and second control user input mechanisms on the application bar remain visually un-obscured by the menu; and
a computer processor being a functional pert of the computer system and activated by the application component and the user interface component to facilitate generating the user interface displays.

12. The computer system of claim 11 wherein the application comprises a business system application.

13. The computer system of claim 12 wherein the user interface component varies a size of the menu based on a number of the additional control user input mechanisms in the group.

14. The computer system of claim 13 wherein the menu is visually connected to the first control user input mechanism.

15. The computer system of claim 11 wherein the user interface component displays the menu with a plurality of groups of additional user input mechanisms, wherein a first of the groups is displayed on the menu in a way that is visually distinct from all remaining groups to indicate a relative importance of the additional user input mechanisms in the first group relative to the additional user input mechanisms in the remaining groups.

16. A computer readable storage medium having computer executable instructions store thereon which, when executed by a computer, cause the computer to perform a method of controlling a computer system, comprising:
displaying a user interface display from the computer system;
displaying, along with the user interface display, an application bar having first and second user input mechanisms;
receiving user actuation of a given one of the first and second user input mechanisms on the application bar; and
in response to receiving user actuation of the given user input mechanism, displaying a menu, corresponding to the given user input mechanism, the menu having a group of additional user input mechanisms, the menu being visually connected to the given user input mechanism and being displayed so the first and second user input mechanisms on the application bar remain visually un-obscured by the menu.

17. The computer readable medium of claim 16 wherein displaying a user interface display from the computer system comprises displaying a form from a business system that comprises the computer system, and wherein displaying the menu with the group of additional user input mechanisms, comprises:
displaying a plurality of groups of additional user input mechanisms on the menu, each group having a corresponding title identifying a subject matter of the corresponding group, and wherein a first group, of the plurality of groups, is displayed in a form that visually distinguishes it from a remainder of the plurality of groups.

18. The computer readable medium of claim 17 wherein the first group has a most important group of user input mechanisms from the additional user input mechanisms displayed on the menu.

19. The computer readable medium of claim 17 wherein displaying the menu comprises:
varying a size of the menu based on a number of the additional user input mechanisms in a largest group of the plurality of groups.

20. The computer readable storage medium of claim 17 wherein displaying the menu comprises:
displaying a visual menu indicator associated with each of the additional user input mechanisms that has an additional menu corresponding to it, wherein actuation one of the additional user input mechanisms having an associated visual menu indicator causes display of a corresponding additional menu, along with the form, the application bar, and the menu.
